(19) United States
(12) Patent Application Publication
(10) Pub. No.: US 2012/0026254 A1
(43) Pub. Date: Feb. 2, 2012

(54) INK SUPPLY DEVICE OF INKJET PRINTER AND BACKFLOW SHUTOFF MECHANISM OF THE SAME

(75) Inventor: Kazutaka Tamaki, Nagano (JP)

(73) Assignee: MIMAKI ENGINEERING CO., LTD., Nagano (JP)

(21) Appl. No.: 12/740,574

(22) PCT Filed: Sep. 28, 2009
(86) PCT No.: PCT/JP2009/004947

§ 371 Date: Jul. 19, 2010

(30) Foreign Application Priority Data
Sep. 29, 2008 (JP) 2008-250652

(51) Int. Cl. B41J 2/175

(52) U.S. Cl. 347/85; 137/565.01

(57) ABSTRACT

An ink supply device for an inkjet printer is provided with a backflow shutoff mechanism (200). The backflow shutoff mechanism (200) is disposed on a line (177) as an air passage which connects a pressure control means for adjusting the inner pressure of a sub tank (120) and the sub tank (120) to allow the pressure control means to adjust the inner pressure of the sub tank (120), and closes the line (177) to shut off inflow of ink toward the pressure control means side when the inner pressure of the sub tank (120) is reduced to a negative pressure by said pressure control means through the line (177) and the ink stored in the sub tank (120) flows out into the line (177).

### TECHNICAL FIELD

The present invention relates to an ink supply device for supplying ink to a print head which ejects ink droplets and a backflow shutoff mechanism mounted on the ink supply device.

### BACKGROUND ART

Inkjet printer is an apparatus which comprises a print head having a large number of nozzles formed therein and which ejects particulate ink droplets from the nozzles to deposit the ink droplets on a print medium while moving the print head relative to the print medium, thereby forming image of information such as characters graphics, patterns, and photographs on a printed surface of the print medium. Since ink is consumed according to the ejection of the ink in the inkjet printer, an ink tank (ink cartridge) of a volume according to the application is mounted on a carriage of the print head or a printer main body. In case of a large-sized commercial inkjet printer for printing large-sized billposters, labarums, and the like, a large amount of ink is consumed in a relatively short time. Therefore, in such a commercial inkjet printer, a large-volume ink tank is generally mounted on a printer main body and is connected to a print head by a tube or the like so that ink is supplied to the print head from the ink tank according to the ejection of ink.

As the inner pressure of the print head exceeds atmospheric pressure, ink is forced out of the nozzles and drops onto the print medium, i.e. so-called “dribbling or drooling of liquid” problem occurs. Therefore, in the inkjet printer, an ink supply device is designed in such a manner as to keep the inner pressure of the print head slightly lower than atmospheric pressure. As a conventional ink supply device, there is known an ink supply device of a “negative-pressure generating type” which comprises an ink tank (main tank) mounted on the printer main body and a sub tank having a small-volume ink chamber between the ink tank and the print head mounted on a carriage, wherein the pressure in the ink chamber of the sub tank is reduced so as to keep the inner pressure of the print head at a slightly negative pressure (see, for example, Patent document 1).

In order to prevent absence of ink supply to the nozzles, the ink supply device of the aforementioned type is controlled such that a predetermined amount of ink is stored in the ink chamber of the sub tank according to, the ejection of ink from the nozzles. As a sample of methods for such control, there is a method of detecting a liquid surface level of ink in the ink chamber and controlling the ink supply according to the detected liquid level of ink. Specifically, control is conducted such that ink is supplied to the ink chamber of the sub tank from the main tank when the liquid surface level of ink lowers to a predetermined lower limit level because of the ejection of ink from the nozzles. As means of detecting a liquid surface level of liquid stored in a container, for example, Patent document 2 discloses an arrangement comprising afloat having a magnet and a sensor (hall element) capable of detecting magnetism from a magnet confronting the same, wherein the float is floated on liquid surface movably in the vertical direction and the sensor (hall element) is disposed at a predetermined level (for example, the lower limit level).

### PRIOR ART DOCUMENTS

### Patent Documents

Patent document 1: JP-A-2004-284207

Patent document 2: JP-A-2001-141547

### SUMMARY OF THE INVENTION

### Problems to be Solved by the Invention

Since replenishment of ink to the sub tank is performed in a state that the sub tank is decompressed as mentioned above, there are advantages that the replenishment of ink is securely performed even when a small-size ink feeding means (pump) is used and that ink never leaks or dribbles from the nozzles of the print head. However, there is a drawback that ink in the ink chamber flows out (flows backward) to a gas flow passage connected to the pressure control means when the replenishment of ink is not stopped due to failure of the level detection sensor or the like and is continued even after the surface level of ink in the ink chamber rises to exceed a predetermined level. In addition, there is a problem that component devices composing of the pressure control means are damaged due to this backward flowing ink. Therefore, there has been taken a measurement of providing a backflow prevention section comprising a sealing float which rises together with the surface level of ink to close an opening formed in the ink chamber connected to the aforementioned gas flow passage when the surface level of ink in the ink chamber of the sub tank rises to exceed the predetermined level. However, even with the backflow prevention section in the sub tank, there are disadvantageous cases, for example, that the sealing float does not keep up with the rise of the surface level of ink because the rise of the surface level of ink is too fast and that the sealing float affixes itself to an inner surface of the ink chamber so that the sealing float does not perform its backflow prevention function.

The present invention is made to address the aforementioned problems and it is an object of the present invention to provide an ink supply device of an inkjet printer and a backflow shutoff mechanism of the same which securely, prevents ink in a sub tank from flowing backward when the ink flows out (flows backward) into a gas flow passage connected to a pressure control means.

### Means for Solving the Problems

To solve the aforementioned problem, a first invention provides an ink supply device for an inkjet printer comprising: a sub tank which is connected to a print head for ejecting ink and which stores the ink; a main tank which is connected to said sub tank and in which the ink to be supplied to said sub tank is stored; an ink sending means (for example, the ink sending unit 115 in the following embodiments) for sending the ink stored in said main tank to said sub tank; and a pressure control means (for example, the sub tank depressurizing unit 140, the sub tank pressurizing unit 150, and the air pump 160 in the following embodiments) for adjusting the inner pressure of said sub tank, wherein said ink supply device further comprises a backflow shutoff means (for example, the backflow shutoff mechanisms 200, 300 in the following embodiments) which is disposed on an air passage (for example, the line 177 of the converging route 171 in the following embodiments) which connects said pressure control means and said sub tank to allow said pressure control means to adjust the inner pressure of said sub tank, and closes said air passage to shutoff inflow of the ink into said pressure control means side when the inner pressure of said sub tank is reduced to a negative pressure by said pressure control means through said air passage and the ink stored in said sub tank flows out into said air passage.

In the ink supply device having the aforementioned structure, it is preferable that said backflow shutoff means comprises: a housing member having an air flowing space (for example, the inner spaces 201, 301 in the following embodiments) formed inside thereof, a first an introduction passage (for example, the introduction passage 204a of the upper-side tube connector 204 and the introduction passage 302a of the housing 302 in the following embodiments) which is connected to said air passage on said pressure control means side to allow communication between said air passage and said air flowing space at an upper portion of said air flowing space, and a second air introduction passage (for example, the derivation passage 205a of the lower tube connector 205 and the derivation passage 304a of the shield member 304 in the following embodiments) which is connected to said air passage on said sub tank side to allow communication between said air passage and said air flowing space; and a float member (for example, the backflow shutoff floats 203, 303 in the following embodiments) which is disposed within said air flowing space and moves vertically because of buoyancy relative to the ink when the ink flows into said air flowing space, wherein when said float member moves upwardly according to the rise of the liquid surface of the ink flowing into said air flowing space through said second air introduction passage, said float member closes an opening on the air flowing space side of said first air introduction passage.

Also in the ink supply device having the aforementioned structure, it is preferable that said backflow shutoff means is formed in said sub tank and is connected to an air introduction port (for example, the shutoff mechanism connector 109 in the following embodiments) composing said air passage on said sub tank side.

To solve the aforementioned problem, a second invention provides a backflow shutoff mechanism (for example, the backflow shutoff mechanisms 200, 300 in the following embodiments) installed in an ink supply device for an inkjet printer, wherein said ink supply device comprises a sub tank which is connected to a print head for ejecting ink and which stores the ink, a main tank which is connected to said sub tank and in which the ink to be supplied to said sub tank is stored, an ink sending means (for example, the ink sending unit 115 in the following embodiments) for sending the ink stored in said main tank to said sub tank, and a pressure control means (for example, the sub tank depressurizing unit 140, the sub tank pressurizing unit 150 and the air pump 160 in the following embodiments) for adjusting the inner pressure of said sub tank, and said backflow shutoff mechanism is disposed on an air passage (for example, the line 177 of the converging route 171 in the following embodiments) which connects said pressure control means and said sub tank to a low said pressure control means to adjust the inner pressure of said sub tank, and comprises: a housing member (for example, the housings 202, 302 in the following embodiments) having an air flowing space (for example, the inner spaces 201, 301 in the following embodiments) formed inside thereof, a first air introduction passage (for example, the introduction passage 204a of the upper-side tube connector 204 and the introduction passage 302a of the housing 302 in the following embodiments) which is connected to said air passage on said pressure control means side to allow communication between said air passage and said air flowing space at an upper portion of said an flowing space, and a second air introduction passage (for example, the derivation passage 205a of the lower tube connector 205 and the derivation passage 304a of the shield member 304 in the following embodiments) which is connected to said air passage on said sub tank side to allow communication between said air passage and said air flowing space; and a float member (for example, the backflow shutoff floats 203, 303 in the following embodiments) which is disposed within said air flowing space and moves vertically because of buoyancy relative to the ink when the ink flows into said air flowing space, wherein when said float member moves upwardly according to the rise of the liquid surface of the ink flowing into said air flowing space through said second air introduction passage, said float member closes an opening on the air flowing space side of said first air introduction passage.

In the backflow shutoff mechanism having the aforementioned structure, it is preferable that said housing member is formed in said sub tank and is connected to an air introduction port (for example, the backflow mechanism connector 109 in the following embodiments) composing said air passage on said sub tank side.

### EFFECT OF THE INVENTION

The ink supply device for an inkjet printer according to the first invention comprises a backflow shutoff means which is disposed on an air passage which connects the pressure control means and the sub tank to adjust the inner pressure of the sub tank, and closes the air passage to shutoff inflow of the ink into the pressure control means side when the inner pressure of the sub tank is reduced to a negative pressure by the pressure control means and the ink stored in the sub tank flows out into the air passage. Therefore, even when the backflow prevention section in the sub tank fails to work for any reason, the backflow of the ink is securely shut off by the backflow shutoff means disposed on the air passage when the ink in the sub tank flows (backward) into the aforementioned air passage. As a result of this, the respective components composing the pressure control means are prevented from being damaged with ink flowing backward.

In the aforementioned ink supply device, it is preferable that the backflow shutoff means comprises a housing member having an air flowing space formed inside thereof, a first air introduction passage which is connected to the air passage on the pressure control means side to allow communication between the air passage and the air flowing space at an upper portion of the air flowing space, and a second air introduction passage which is connected to the air passage on the sub tank side to allow communication between the air passage and the air flowing space; and afloat member which is disposed within the air flowing space and moves vertically because of buoyancy relative to the ink when the ink flows into the air flowing space, wherein when the float member moves upwardly according to the rise of the liquid surface of the ink flowing into the air flowing space through the second air introduction passage, the float member closes an opening at the air flowing space side of the first air introduction passage. According to this structure, when the ink in the sub tank flows backward, the float member moves upward according to the liquid surface of the ink flowing into the air flowing space of the housing through the second air introduction passage and closes the opening on the air flowing space side of the first air introduction passage before the ink reaches the opening, thereby preventing the ink from reaching the air passage on the pressure control means side through the first air passage. Therefore, backflow of ink can be securely shut off by the backflow shutoff means having a simple structure as mentioned above without the necessity of using a complex arrangement composed of a sensor for detecting backflow of ink, an electromagnetic shutoff valve which closes the air passage according to a signal from the sensor indicating the occurrence of backflow.

In the aforementioned ink supply device, it is preferable that the backflow shutoff means is formed in the sub tank and is connected to an air introduction port composing the air passage on the sub tank side. According to this structure, ink flowing backward from the sub tank to the air passage reaches the backflow prevention means soon and the backflow of the ink is shut off by the backflow shutoff means as mentioned above, thereby minimizing the range of the air passage contaminated with ink flowing backward. Therefore, the number of parts which will be forced to be replaced because of being contaminated when backflow of ink occurs is reduced. As a result of this, an effect of reducing the maintenance cost of the inkjet printer is obtained.

The backflow shutoff device according to the second invention comprises a housing member which is disposed on the air passage for connecting the pressure control means and the sub tank and adjusting the inner pressure of the sub tank and has an air flowing space formed inside thereof, a first air introduction passage which is connected to the air passage on the pressure control means side to allow communication between the air passage and the air flowing space at an upper portion of the air flowing space, and a second air introduction passage which is connected to the air passage on the sub tank side to allow communication between the air passage and the air flowing space; and a float member which is disposed within the air flowing space and moves vertically because of buoyancy relative to the ink when the ink flows into the air flowing space, wherein when the float member moves upwardly according to the rise of the liquid surface of the ink flowing into the air flowing space through the second air introduction passage, the float member closes an opening on the air flowing space side of the first air introduction passage. According to this structure, the float member moves upward according to the liquid surface of the ink flowing into the air flowing space of the housing through the second air introduction passage and closes the opening on the air flowing space side of the first air introduction passage before the ink reaches the opening, thereby preventing the ink from flowing out through the first air passage. Therefore, backflow of ink can be securely shut off by the backflow shutoff device having a simple structure as mentioned above without the necessity of using a complex arrangement composed of a sensor for detecting inflow of ink, an electromagnetic shutoff valve which closes the first air introduction passage according to a signal from the sensor indicating the inflow of ink. As a result of this, the respective components composing the pressure control means are prevented from being damaged with ink flowing backward.

In the aforementioned backflow shutoff device, it is preferable that the housing member is formed in the sub tank and is connected to an air introduction port composing the air passage on the sub tank side. According to this structure, ink flowing backward from the sub tank to the air passage reaches the backflow shutoff device soon and the backflow of the ink is shut off by the backflow shutoff device as mentioned above, thereby minimizing the range of the air passage contaminated with ink flowing backward. Therefore, the number of parts which will be forced to be replaced because of being contaminated when backflow of ink occurs is reduced. As a result of this, an effect of reducing the maintenance cost of the inkjet printer is obtained.

### BRIEF DESCRIPTION OF THE DRAWINGS

FIG. 1 is an external perspective view showing a printer apparatus as an application example of the present invention as seen diagonally from the front.

FIG. 2 is an external perspective view showing the printer apparatus as seen diagonally from the back.

FIG. 3 is a front view showing main components of an apparatus body of the printer apparatus.

FIG. 4 is a perspective view showing a carriage and peripheries thereof in the printer apparatus.

FIG. 5 is a system diagram of an ink supply device.

FIG. 6 is an external perspective view showing a sub tank and a backflow shutoff mechanism disposed on the carriage.

FIG. 7 is a schematic block diagram of the ink supply device.

FIGS. 8(a)-8(b) are illustrations showing a structure of the backflow shutoff mechanism according to the present invention, wherein FIG. 8(a) is a side view of the backflow shutoff mechanism (some parts are omitted) and FIG. 8(b) is a perspective view of the backflow shutoff mechanism (some parts are omitted).

FIG. 9(a) is a sectional view of the backflow shutoff mechanism taken along a line IX-IX of FIG. 8(a) and FIG. 9(b) is a side view of the backflow shutoff mechanism (some parts are omitted) in a state where a backflow shutoff float is moved vertically.

FIG. 10 is a side view of a second backflow shutoff mechanism (some parts are omitted) according to the present invention.

### BEST MODE FOR CARRYING OUT THE INVENTION

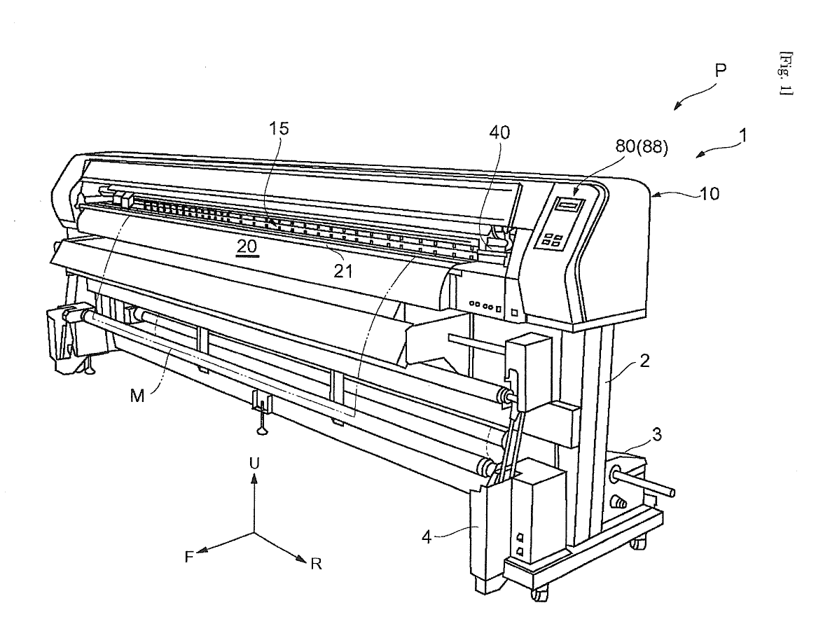

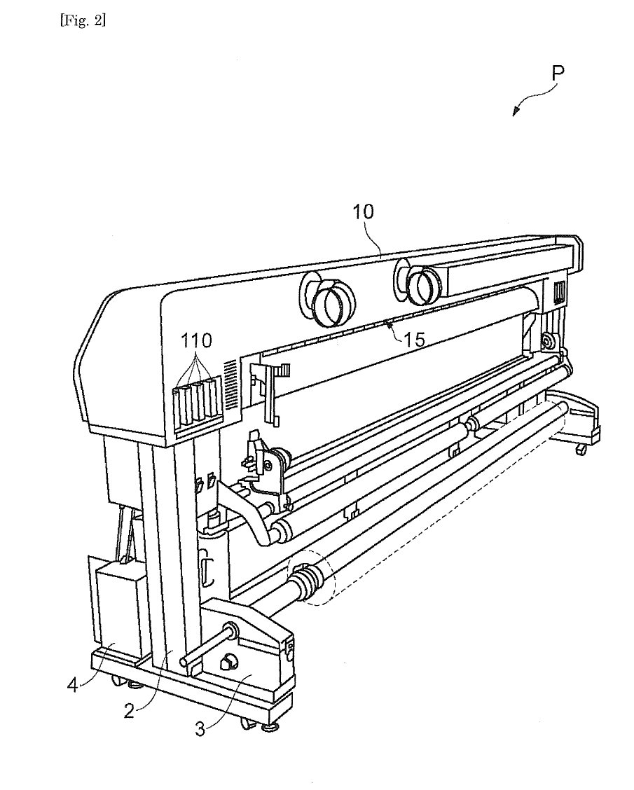

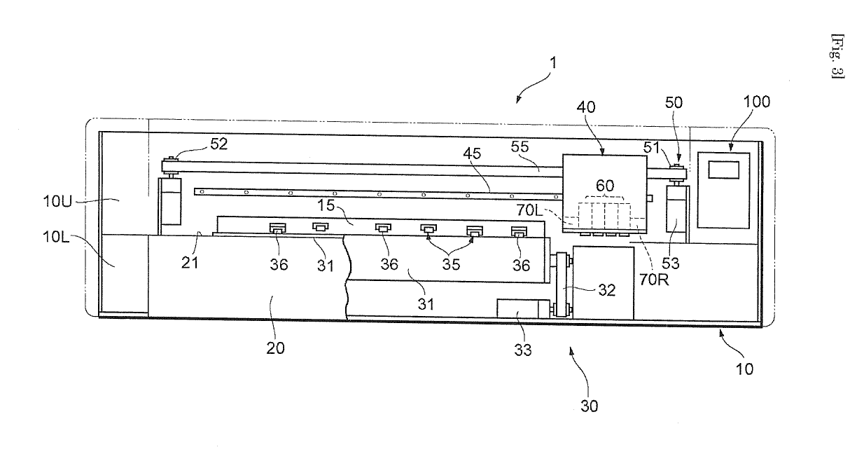

Hereinafter, preferred embodiments of the present invention will be described with reference to attached drawings. As an example of inkjet printers to which the present invention is applied, a structural example of an inkjet printer (hereinafter, referred to as “printer apparatus”) is employed in the following description. The structural example has orthogonal axes extending along a print surface of which one is used for moving a print medium and the other one is used for moving print heads, and is of a UV curable type using ultraviolet curable inks (hereinafter, referred to as “UV inks”) which are cured by an irradiation with ultraviolet light. A perspective view of a printer apparatus P of this embodiment as seen diagonally from the front is shown in FIG. 1, a perspective view showing the same as seen diagonally from the back is shown in FIG. 2, and main components of an apparatus body 1 of the printer apparatus P are shown in FIG. 3. First, the entire structure of the printer apparatus P will be outlined with reference to these drawings. In the following description, the directions indicated by arrows F, R, and U in FIG. 1 will be forward, rightward, and upward directions, respectively.

The printer apparatus P mainly comprises an apparatus body 1 for conducting the image forming function, a feeding mechanism 3 which is disposed in front of and behind a supporting portion 2 supporting the apparatus body 1 to feed a print medium M as a non-printed material in a rolled state, and a winding mechanism 4 for winding up the print medium M which has been printed.

The apparatus body 1 comprises a frame 10 forming the framing structure. The frame 10 has a landscape window-like medium through portion 15 which is formed at a middle portion in the vertical direction of the frame 10 and through which the print medium M is passed in the anteroposterior direction. The frame 10 comprises a lower frame 10L, which is positioned on the lower side of the medium through portion 15 and is provided with a platen 20 for supporting the print medium M and with a medium moving mechanism 30 for moving the print medium M supported by the platen 20 in the anteroposterior direction, and an upper frame 10U, which is positioned on the upper side of the medium through portion 15 and is provided with a carriage 40 holding the print heads 60 and with a carriage moving mechanism 50 for moving the carriage 40 in the lateral direction. The apparatus body 1 is provided with a control unit 80 for controlling the operations of respective components of the printer apparatus P such as the anteroposterior movement of the print medium M by the medium moving mechanism 30, the lateral movement of the carriage 40 by the carriage moving mechanism 50, the ink ejection by the print heads 60, and the ink supply by an ink supply device 100 as will be described later. In addition, a control panel 88 is disposed in front of the apparatus body 1.

The platen 20 is mounted on the lower frame 10L to extend in the anteroposterior direction below the medium through portion 15 and has a medium supporting portion 21 for supporting the print medium M horizontally which is an image forming area of a band-like shape extending in the lateral direction for the print heads 60. The medium supporting portion 21 has a large number of small suction holes formed therein which communicate with a decompression chamber (not shown) formed below the medium supporting portion 21. When the decompression chamber is set to have a negative pressure by the action of a vacuum generator, the print medium M is sucked to stick to the medium supporting portion 21 so as to prevent displacement of the print medium M during printing.

The medium moving mechanism 30 comprises a cylindrical feeding roller 31 which is disposed such that an upper periphery is exposed to the platen and which extends in the lateral direction, a roller driving motor 33 for rotating the feeding roller 31 via a timing belt 32, and the like. Above the feeding roller 31, a plurality of roller assemblies 35, each having a pinch roller 36 rotatable in the anteroposterior direction, are disposed to be aligned in the lateral direction. The roller assemblies 35 are adapted to be selectively have a clamping position where the pinch rollers 36 are pressed against the feeding roller 31 and an unclamping position where the pinch rollers 36 are spaced apart from the feeding roller 31. By driving the roller driving motor 33 in a state that the roller assemblies 35 are set at the clamping position so that the print medium M is clamped between the pinch rollers 36 and the feeding roller 31, the print medium M is fed for a distance corresponding to the rotational angle of the feeding roller 31 (a drive control value outputted from the control unit 80) in the anteroposterior direction. It should be noted that the state where the roller assemblies 35 are set at the clamping position and the state where the roller assemblies 35 are set at the unclamping position are both shown in FIG. 3.

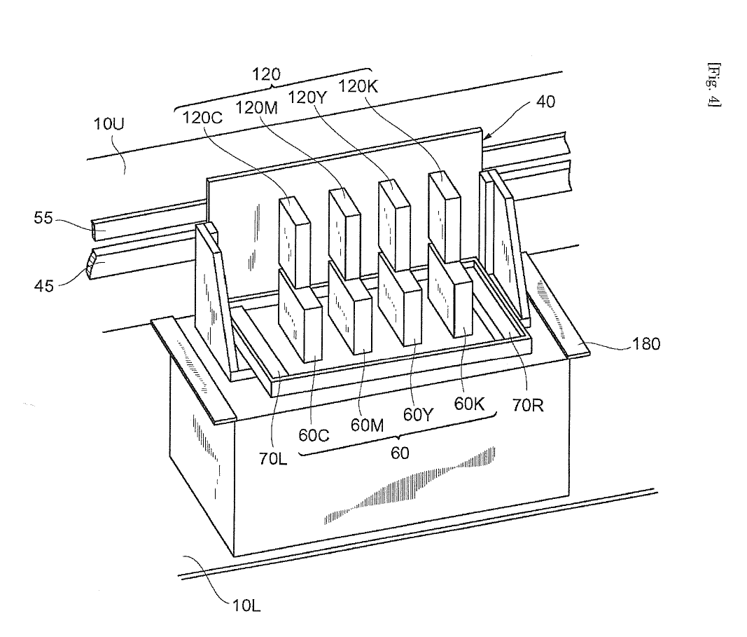

A guide rail 45 is attached to the upper frame 10U extending parallel to the feeding roller 31 and the carriage 40 is supported on the guide rail 45 via a slide block (not shown) such that the carriage 40 can freely move in the lateral direction. The carriage 40 is driven by a carriage driving mechanism 50 as will be described in the following. In the carriage 40, the print heads 60 for ejecting UV inks are disposed such that nozzle faces as the lower faces of the heads are spaced apart from the medium supporting portion 21 of the platen 20 by a predetermined gap to face the same. Generally, the print heads 60 comprise print heads of which number corresponds to the number of inks used in the printer apparatus P and which are aligned in the lateral direction. For example, in case of a printer apparatus using UV inks of four basic colors, i.e. cyan (C), magenta (M), yellow (Y), and black (K) and having ink cartridges corresponding to the respective colors, four print heads 60 (a first print head 60C, a second print head 60M, a third print head 60Y, and a fourth print head 60K) corresponding to the respective ink cartridges are provided as shown in a perspective view of the periphery of the carriage 40 in FIG. 4. In the carriage 40, sub tanks 120 (a first sub tank 120C, a second sub tank 120M, a third sub tank 120Y, and a fourth sub tank 120K) of the ink supply device 100 as will be described in detail later are provided to correspond to the print heads 60C, 60M, 60Y, and 60K, respectively. A tray-shaped ink tray 180 for receiving UV inks is placed below the print heads 60 (60C, 60M, 60Y, and 60K) in a state that the carriage 40 is set at the reference position (so-called “home position”) when the printer apparatus does not work. The method for driving the print heads 60 (the method of ejecting ink fine particles) may be the thermal method or the piezo method.

On the left and right sides of the carriage 40, UV light sources for irradiating the UV inks ejected from the print heads to the print medium M with ultraviolet lights to cure the UV inks are arranged. The UV light sources are a left UV light source 70L located on the left side of the carriage 40 and a right UV light source 70R located on the right side of the carriage 40 so that the first through fourth print heads 60C 60M, 60Y, and 60K arranged in the carriage 40 are sandwiched from the left and right by the left and right UV light sources 70L, 70R. Each of the left UV light source 70L and the right UV light source 70R is a light source, for example a UV lamp or UV-LED, which emits ultraviolet light of which wavelength A is in a range of from about 100 to 380 nm. The on-off actions of the left and right UV light sources 70L, 70R are controlled by the control unit 80 according to the movement of the carriage 40 by the carriage driving mechanism 50 and the ejection of the inks from the print heads 60.

As shown in FIG. 3, the carriage moving mechanism 50 comprises a driving pulley 51 and a driven pulley 52 which are disposed in left and right portions of the frame 10 such that the guide rail 45 is arranged between the driving pulley 51 and the driven pulley 52, a carriage driving motor 53 for rotating the driving pulley 51, and an endless belt-like timing belt 55 wound around the driving pulley 51 and the driven pulley 52 with some tension. The carriage 40 is connected and fixed to the timing belt 55. By driving the carriage driving motor 53, the carriage 40 supported by the guide rail is moved above the platen 20 in the lateral direction for a distance according to a rotational angle of the carriage driving motor 53 (a drive controlled value outputted from the control unit 80).

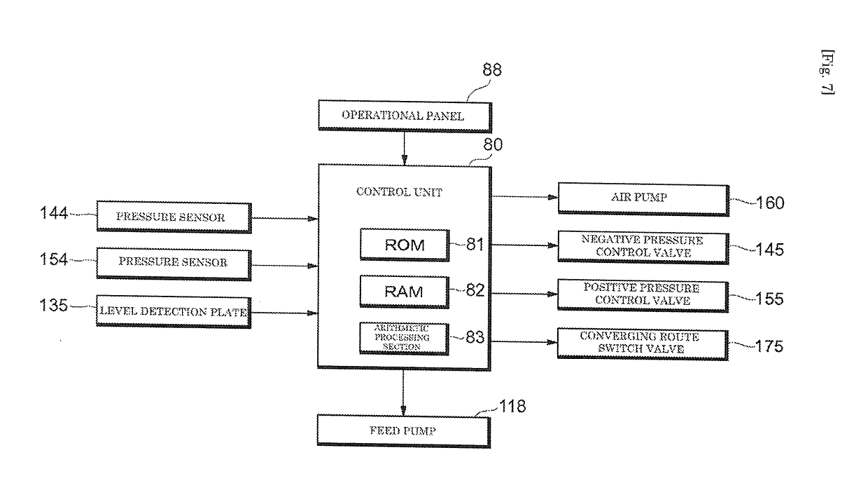

As shown in FIG. 7, the control unit 80 comprises a ROM 81 in which a control program for controlling the actions of the respective components of the printer apparatus P is written, a RAM 82 in which a print program for forming images on the print medium M and the like are temporarily stored, an arithmetic processing section 83 which conducts arithmetic processing based on the print program read from the RAM 82 and operational signals inputted through an operational panel 88 to control the actions of the respective components according to the control program, and the operational panel 88 on which a display panel for displaying the operational state of the, printer apparatus P and various operational switches are provided, whereby the control unit 80 controls the anteroposterior movement of the print medium M by the medium moving mechanism 30, the lateral movement of the carriage 40 by the carriage moving mechanism 50, the ejection of inks from nozzles of the print heads 60, the supply of inks by the ink, supply device 100, and the like.

For example, in case of forming images on the print medium M based on the print program read by the control unit 80, the print medium M and the print heads 60 are moved relative to each other by combination of the anteroposterior movement of the print medium M by the medium moving mechanism 30 and the lateral movement of the carriage 40 by the carriage moving mechanism 50. During this, inks are ejected onto the print medium M from the print heads 60 and the UV light source, positioned behind the carriage 40 in the moving direction, (for example, the left UV light source 70L when the carriage is moved rightward) is turned ON, thereby forming image of information according to the print program.

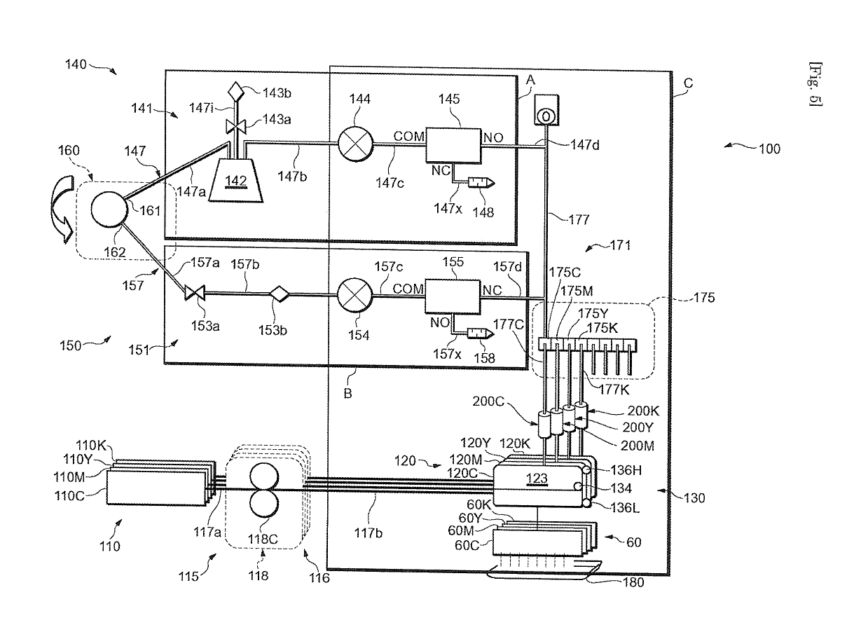

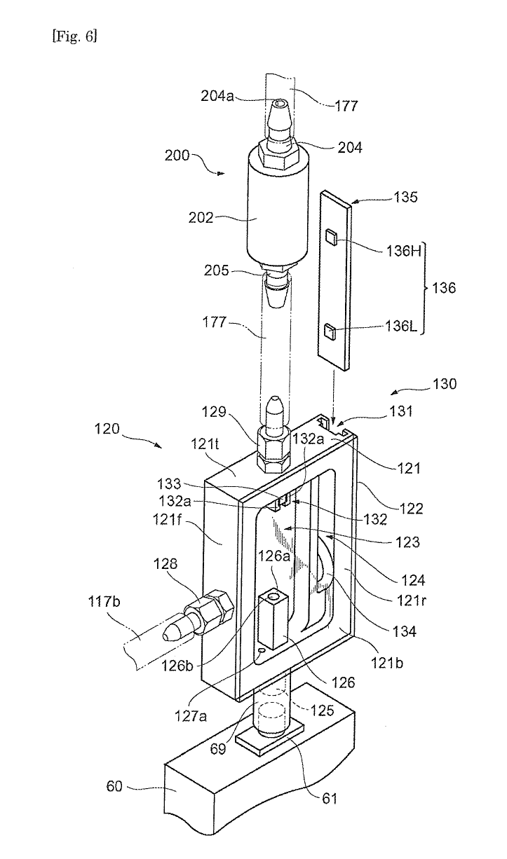

In the printer apparatus P having the structure outlined in the above, UV inks are supplied to the print heads 60 disposed on the carriage 40 by the ink supply device 100. FIG. 5 is a system diagram of the ink supply device 100, FIG. 6 is an external perspective view of the sub tank 120 and a backflow shutoff mechanism 200, and FIG. 7 is a schematic block diagram of the ink supply device 100.

As shown in FIG. 5, the ink supply device 100 comprises the sub tanks 120 connected to the print heads 60, main tanks 110 which are connected to the sub tanks 120 and in which UV inks to be supplied to the sub tanks 120 are stored, a sub tank depressurizing unit 140 for reducing the inner pressure of the sub tanks 120 to negative pressure, a sub tank pressurizing unit 150 for increasing the inner pressure of the sub tanks 120 to positive pressure, ink sending units 115 for sending the UV inks stored in the main tanks 110 to the sub tanks 120, and the like. The sub tank depressurizing unit 140 and the sub tank pressurizing unit 150 have a common single air pump 160.

The main tanks 110 are designed to store the UV inks of volume corresponding to the consumption quantities per a unit period of time in the printer apparatus P. In this embodiment, corresponding to the aforementioned four colors C. M, Y, and K, cartridge type main tanks 110 (a first main tank 110C, a second main tank 110M, a third main tank 110Y, and a fourth main tank 110K) of about 500 ml for the respective colors are used. These main tanks 110 are detachably attached to the back surface of the apparatus body 1 (see FIG. 2). The form of the main tanks 110 may be another form such as a cylindrical vessel or a flexible envelope. The installation position of the ink tanks may be suitably set at the front face or the top of the apparatus body 1, or a position separate from the apparatus body 1.

As shown in FIG. 6, the sub tank 120 comprises a reservoir member 121 having a thin box-like shape which opens to one side (the right) and is long in the vertical direction as seen in a side view, and a lid member 122 for covering and closing an opening of the reservoir member 121. Inside a tank which is formed by closing with the lid member 122, an ink storage chamber 123 for storing UV ink is formed. In addition, a float receiving portion 124 is formed which is a groove-like portion extending vertically on the rear side of the ink storage chamber 123. Inside the float receiving portion 124, a disc-like level detecting float 134, which has a magnet fixed to the center thereof and floats on the UV ink, is accommodated to freely move in the vertical direction.

As for the sub tank 120, the lid member 122 is integrally attached to the reservoir member 121 by applying sealant or adhesive on the peripheries of the opening of the reservoir member 121 and is strongly connected by fastening means such as screws (not shown) so that the ink storage chamber 123 is held in the sealed state. At least one of the lid member 122 and the reservoir member 121 is made of a transparent or semi-transparent material for the purpose of observing the storing state of UV ink in the ink storage chamber 123 and the floating state of the level detecting float 134 on the UV ink from the outside. In this embodiment, the lid member 122 is made of a transparent material.

Formed in the bottom side of the sub tank 120 is a short cylindrical connecter portion 125 projecting downwardly from a bottom wall 121b of the reservoir member 121. Above the connector portion 125, a block-like duct portion 126 is formed to extend from the bottom wall 121b into the inside of the ink storage chamber 123 upwardly. A first derivation passage 127a is formed to penetrate vertically the bottom wall 121b to connect the bottom of the ink storage chamber 123 and the connecter portion 125 and a second derivation passage 126b is formed to penetrate vertically the duct portion 126 and the bottom wall 121b to connect the top 126a of the duct portion 126 and the connector portion 125. Therefore, the ink storage chamber 123 of the sub tank 120 and the ink chamber of the print head 60 are connected to each other via the first derivation passage 127a and the second derivation passage 126b. It should be noted that disposed between the tube 69 and the print head 60 is a filter 61 for filtering UV ink passing therethrough.

On the rear side of the sub tank 120, a sub tank reserve detecting unit 130 for detecting the reserved state of the UV ink in the ink storage chamber 123 is provided. The sub tank reserve detecting unit 130 comprises the level detecting float 134 which is accommodated in a float receiving portion 124 extending in the vertical direction such that the level detecting float 134 can freely move in the vertical direction and thus moves in the vertical direction according to the surface of the UV ink in the ink storage chamber and a level detection plate 135 which detects the liquid surface level of the UV ink by detecting the level detecting float 134.

Formed in a rear wall 121r of the reservoir member 121 is a plate receiving portion 131 which has a dovetail groove-like shape extending in the vertical direction. The level detection plate 135, to which a plurality of magnetic sensors 136 (136H, 136L) are attached, is installed and fixed to the plate receiving portion 131. That is, the level detection plate 135 is disposed to face the level detecting float 134 via the rear wall 121r. The magnet fixed to the level detecting float 134 in the ink storage chamber 123 (the float receiving portion 124) is detected by the magnetic sensors 136, thereby detecting the vertical position of the level detecting float 134, that is, detecting the surface level of the UV ink retained in the ink storage chamber 123.

This embodiment employs such an arrangement that, as the magnetic sensors 136, two magnetic sensors, that is, a Hi detection sensor 136H for detecting that the ink storage chamber 123 is filled with UV ink so that the surface of the UV ink is at a reference level for filling and a Lo detection sensor 136L for detecting that the UV ink in the ink storage chamber 123 is consumed and is thus at a level lower than a predetermined value are attached to the level detection plate 135. It should be noted that an arrangement in which three or more magnetic sensors 136 are attached so as to sequentially detect changes in the surface level in the ink storage chamber according to changes in magnetism may be employed. An output signal from the level detection plate 135 is inputted into the control unit 80.

On the front side of the sub tank 120, an ink introduction passage is formed at a middle position in the vertical direction to penetrate the front wall 121f of the reservoir member 121 in the anteroposterior direction and a tube connector 128 is connected to the ink introduction passage. On the upper side of the sub tank 120, an air introduction passage is formed to penetrate the top wall 121t of the reservoir member 121 and a tube connector 129 is connected to the air introduction passage. Inside the ink storage chamber 123 below the air introduction passage (the tube connector 129), a backflow prevention section 132 is attached to the top wall 121t.

The backflow prevent on section 132 comprises float supporting members 132a which are paired as front and rear members and which extend downwardly from the top wall 121t and are folded forward and backward, and a sealing float 133 which is vertically movably accommodated in a sealing float accommodation space formed between the front and rear float supporting members 132a so that the sealing float 133 freely moves in the vertical direction together with the liquid surface of the UV ink in the ink storage chamber. When the sealing float 133 moves to the uppermost position in the sealing float accommodation space together with the liquid surface of the UV ink and reaches the uppermost position, the sealing float 133 comes in contact with the top wall 121t and closes the lower end opening of the aforementioned air introduction passage. The sealing float 133 is structured such that the sealing float 133 is floated on the liquid surface of the UV ink and moves vertically together with the liquid surface of the UV ink, but the sealing float 133 is not moved vertically due to suction force when air in the ink storage chamber 123 is sucked through the air introduction passage by the sub tank depressurizing unit 140 or the like.

As shown in FIG. 5, each of the ink sending units 15 is composed of a main supply route 116 connecting the main tank 110 and the sub tank 120. The main supply route 116 comprises an ink suction line 117a of which one end is connected to the main tank 110 and the other end is connected to a feed pump 118, an ink delivery line 117b of which one end is connected to the feed pump 118 and the other end is connected the tube connector 128 of the sub tank 120, and the feed pump 118 which is disposed in the apparatus body 1 between the main tank 110 and the sub tank 120 to suck UV ink stored in the main tank 110 through the ink suction line 117a to supply the UV ink to the sub tank 120 through the ink delivery line 117b.

The feed pump 118 is a pump capable of sucking the UV ink from the main tank 110 and sending the UV ink into the sub tank 120 even in a state that the ink suction line 117a is not filled with the UV ink, that is, the UV ink is mixed with air and also capable of cutting off the pressure from the ink suction line 117a and the ink delivery line 117b. For example, a tube pump or a diaphragm pump may be preferably used as the feed pump 118.

The sub tank depressurizing unit 140 is composed of a negative pressure route 141 connecting the sub tank 120 and an inlet 161 of the air pump 160. The negative pressure route 141 comprises an air chamber 142 composed of a sealed vessel, a pressure sensor 144 for detecting pressure of the negative pressure route 141, a negative pressure control valve 145 for opening and closing the negative pressure route 141, and lines 147 (147a, 147b, 147c, 147d) composed of tubes connecting these components to connect the inlet 161 of the air pump and the sub tank 120, the main components being shown and surrounded by a frame A in FIG. 5. It should be noted that components surrounded by a frame C in FIG. 5 are disposed in the carriage 40 and components outside of the frame C are disposed in the apparatus body 1.

The air chamber 142 is connected to the inlet 161 of the air pump through the line 147a so that air in the chamber is discharged by the action of the air pump 160 so as to reduce the pressure of the air chamber 142 into a negative pressure state. The air chamber 142 is provided with an air introduction line 147i for introducing air into the chamber of which pressure is reduced into a negative pressure. The air introduction line 147i has a flow regulating valve 143a for adjusting the flow rate of air and an air filter 143b for dust removal.

In a state that the air pump 160 and the sub tank 120 are connected via the negative pressure route 141, the flow regulating valve 143a keeps the inner pressure of the air chamber 142 constant by adjusting the flow rate of air entering into the air chamber 142. Therefore, the inner pressure of the ink storage chambers 123 is set to be a predetermined value (for example, −1.2 kPa: hereinafter referred to as “preset negative pressure”) in a range of from about −1 to −2 kPa which is suitable for meniscus formation at the nozzles of the print heads 60. As mentioned above, the air chamber 142 functions as a buffer tank which absorbs pulsation in air suction by the action of the air pump 160 and keeps the inner pressure of the sub tanks 120 at the constant preset negative pressure.

The negative pressure control valve 145 is an electromagnetic value which is positioned between the air chamber 142 and the sub tanks 120 and is disposed in the carriage 40 and which switches the line 147c on the air chamber 147 side and the line 147d on the sub tank 120 side between the connected state and the disconnected state and. In this embodiment, a three-way valve is employed as the negative pressure control valve 145 so that the line 147c is connected to a common port (COM) of the negative pressure control valve 145, the line 147d is connected to a normal open port (NO) of the negative pressure control valve 145, and a normal closed, port (NC) of the negative pressure control valve 145 is opened to atmosphere via a line 147x and a silencer 148.

Therefore, when the negative pressure control valve 145 is in the OFF state (during normal operation such as printing or waiting), the line 147c and the line 147d are connected so as to set the negative pressure route 141 in the communicating state so that the inlet 161 of the air pump 160 and the sub tanks 120 are connected via a converging route 171 as will be described later. On the other hand, when the negative pressure control valve 145 is in the ON state (such as during the ink filling or cleaning), the line 147c and the line 147d are disconnected so that the negative pressure route 141 is shut off and, at the same time, the line 147c is connected to the line 147x so as to open a route on the inlet side of the air pump 160 to the atmosphere. The negative pressure control valve 145 is connected to the control unit 80 so that the ON/OFF of the negative pressure control valve 145 is controlled by the control unit 80.

The pressure sensor 144 is a pressure sensor of a gauge pressure type which has a detection range about ±5 kPa and is disposed between the air chamber 142 and the negative pressure control valve 145. The pressure sensor 144 detects the pressure of the line 147 near the sub tanks. Specifically, in a state that the negative pressure control valve 145 is turned OFF so that the air pump 160 and the sub tanks 120 are connected via the negative pressure route 141, a pressure (for example, a pressure of about −1.3 kPa) obtained by adding a pressure loss due to the line reaching the sub tanks 120 to aforementioned preset negative pressure is detected by the pressure sensor 144. Paradoxically, the inner pressure of the ink storage chambers 123 is set to the preset negative pressure by setting the flow regulating valve 143a (default setting) such that the pressure detected by the pressure sensor 144 becomes to the aforementioned pressure value. Therefore, it is possible to detect whether or not the pressure in the ink storage chambers 123 is set to the preset negative pressure by monitoring the detected pressure of the pressure sensor 144. The detection signal of the pressure sensor 144 is inputted into the control unit 80.

The sub tank pressurizing unit 150 is composed of a positive pressure route 151 connecting the sub tanks 120 and an outlet 162 of the air pump 160. The positive pressure route 151 comprises a flow regulating valve 153a for adjusting the flow rate of air flowing into the positive pressure route 151, an air filter 153b for removing dust from air flowing toward the sub tanks 120, a pressure sensor 154 for detecting the pressure of the positive pressure route 151, a positive pressure control valve 155 for opening and closing the positive pressure route 151, and lines 157 (157a, 157b, 157c, 157d) composed of tubes connecting these components to connect the outlet 162 of the air pump and the sub tanks 120, the main components being shown and surrounded by a frame B in FIG. 5.

The flow regulating valve 153a is a valve for preventing the inner pressure of the ink storage chambers 123 from rising to a value exceeding a predetermined value by adjusting the flow rate of air flowing through the positive pressure route 151 in a state where the air pump 160 and the sub tanks 120 are connected via the positive pressure route 151. The flow regulating valve 153a adjusts the flow rate such that the inner pressure of the sub tanks 120 becomes about 20 kPa.

The positive pressure control valve 155 is an electromagnetic value which is positioned between the flow regulating valve 153a and the sub tanks 120 and is disposed in the carriage 40 and which switches the line 157c and the line 157d between the connected state and the disconnected state. In this embodiment, a three-way valve is employed as the positive pressure cont of valve 155 so that the line 157c is connected to a common port (COM) of the positive pressure control valve 155, the line 157d is connected to a normal closed port (NC) of the positive pressure control valve 155, and a normal open port (NO) of the positive pressure control valve 155 is opened to atmosphere via a line 157x and a silencer 158.

Therefore, when the positive pressure control valve 155 is in the OFF state (during normal operation such as printing or waiting), the line 157c and the line 157d are disconnected so that the positive pressure route 151 is shut off and, at the same time, the line 157c is connected to the line 157x so as to open the positive pressure route on the outlet side of the air pump 160 to the atmosphere. On the other hand, when the positive pressure control valve 155 is in the ON state (such as during the ink filling or cleaning), the line 157c and the line 157d are connected so as to set the positive pressure route 151 in the communicating state so that the outlet 162 of the air pump 160 and the sub tanks 120 are connected via the converging route 171. The positive pressure control valve 155 is connected to the control unit 80 so that the ON/OFF of the positive pressure control valve 155 is controlled by the control unit 80.

The pressure sensor 154 is a pressure sensor of a gauge pressure type which has a detection range about ±50 kPa and is disposed in the carriage 40. The pressure sensor 154 detects the pressure of the line 157 near the sub tanks. Specifically, in a state that the positive pressure control valve 155 is turned ON so that the air pump 160 and the sub tanks 120 are connected via the positive pressure route 151, a pressure applied to the sub tanks 120 is detected. Therefore, it is possible to detect whether or not the pressure in the ink storage chambers 123 is set to the preset positive pressure by monitoring the detected pressure of the pressure sensor 154. The detection signal of the pressure sensor 154 is inputted into the control unit 80.

The air pump 160 is a pump which sucks air from the negative pressure route 141 connected to the inlet 161, and discharges the sucked air into the positive pressure route 151 connected to the outlet 162 and which is thus in a form of producing a predetermined positive pressure and a predetermined negative pressure at the outlet 162 and the inlet 161, respectively. That is, the air pump 160 produces a predetermined negative pressure at the inlet 161 when the negative pressure route 141 is closed, while the air pump 160 produces a predetermined positive pressure at the outlet 162 when the positive pressure route 151 is closed. For example, as this pump, a diaphragm pump capable of producing positive and negative pressures of about ±40 kPa is preferably employed.

The negative pressure route 141 and the positive pressure route 151 converge on the way to the sub tanks 120 so that the converging route 171 is formed. The converging route 171 comprises a line 177 which is connected to the sub tanks and on which the line 147d of the negative pressure route and the line 157d of the positive pressure route are converged, and a converging route switch valve 175 which is provided on the line 177 for opening and closing the converging route 171. The converging route switch valves 175 are provided to correspond to the sub tanks 120, respectively. In this embodiment, the converging route 171 (the line 177) is branched into four routes at the converging route switch valve 175 so that the converging route switch valve 175 is designed to open and close the branched converging routes (lines 177C, 177M, 177Y, and 177K, numerals of some of which are omitted), respectively.

That is, the converging route switch valve 175 is an electromagnetic valve of manifold type having a common input port connected to the line 177, four valves and output ports corresponding to the four sub tanks so that the first through fourth converging switch valves 175C, 175M, 175Y, and 175K corresponding to the first through fourth sub tanks 120C, 120M, 120Y, and 120K can independently open and close the converging route 171. The operation of the converging route switch valve 175 is controlled by the control unit 80.

The number of branches of the converging route 171 may be arbitrarily set according to the number of the print heads 60. For example, in case of a structure having a single print head 60, the converging route switch valve 175 may use a single electromagnetic shut-off valve. In case of a printer apparatus having eight print heads, the converging route switch valve 175 may use an eight-port type electromagnetic valve (or two four-port type electromagnetic valves) as shown in FIG. 5.

Each line 177 connecting the converging route switch valve 175 and the sub tank 120 is provided with a backflow shutoff mechanism 200 which shuts off the line 177 when the UV ink flows out from the sub tank 120 toward the converging route switch valve 175 through the line 177 (this phenomenon will be called “backflow of UV ink”) (see FIG. 5 and FIG. 6). That is, in this embodiment, the lines 177C, 177M, 177Y, 177K connecting the first through fourth sub tanks 120C, 120M, 120Y, 120K and the first through fourth converging route switch valves 175C, 175M, 175Y, 175K are provided with the first through fourth backflow shutoff mechanisms 200C, 200M, 200Y, 200K, respectively.

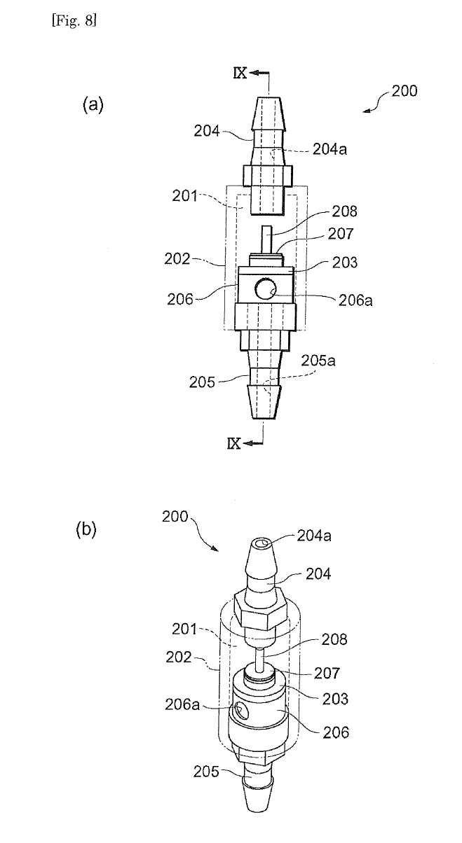

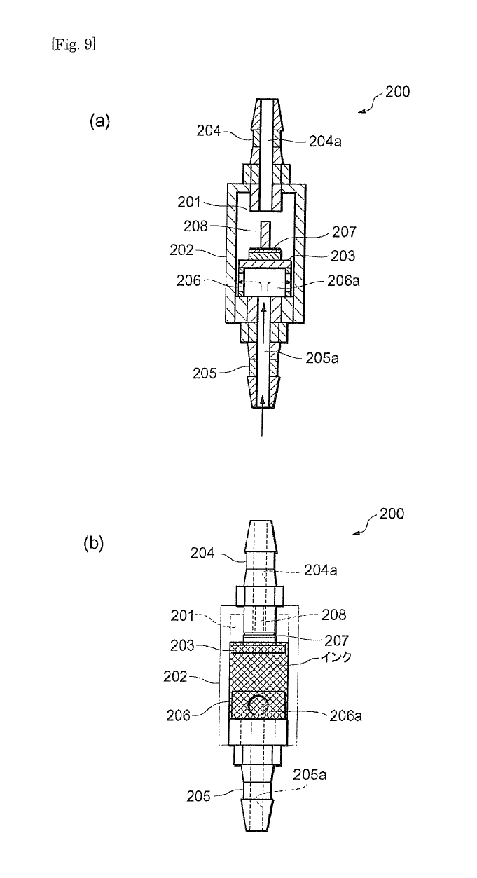

As shown in FIG. 8, the backflow shutoff mechanism 200 mainly comprises a cylindrical housing 202 having an inner space 201 and a backflow shutoff float 203 which is vertically movably accommodated in the inner space 201 and which moves vertically together with the liquid surface of the UV ink entering in the inner space 201. In FIGS. 8(a), 8(b) and 9(b), the housing 202 is shown by chain double-dashed lines for the purpose of showing the structure inside of the housing 202.

In an upper portion of the backflow shutoff mechanism 200, a connector mounting hole is formed to vertically penetrate the top wall of the housing 202 and an upper tube connector 204 is fitted in the connector mounting hole so that a lower portion of the upper tube connector 204 projects into the inner space 201. The line 177 on a side of the converging route switch valve 175 is connected to an upper portion of the upper side tube connector 204 so that the converging route 171 and the inner space 201 of the housing are connected through an introduction passage 204a vertically penetrating the upper tube connector 204. Also in a lower portion of the backflow shutoff mechanism 200, a connector mounting hole is formed in the bottom of the housing 202 and a lower tube connector 205 is fitted in the connector mounting hole so that an upper portion of the lower tube connector 205 is exposed to the inner space 201. The line 177 on a side of the sub tank 120 is connected to a lower portion of the lower tube connector 205 so that the inner space 201 of the housing and the sub tank 120 are connected through the line 177 and a derivation passage 205a vertically penetrating the lower tube connector 205.

In the inner space 201 of the housing 202, a cylindrical supporting member 206 opening in the vertical direction is disposed on the upper end of the lower tube connector 205 exposed to the inner space 201 at the bottom of the housing 202. The backflow shutoff float 203 is disposed on the supporting member 206. The supporting member 206 has through holes 206a formed in a peripheral surface thereof. Normally (when no backflow UV ink is stored in the inner space 201), the communication between the inner space 201 of the housing and the derivation passage 205a of the lower tube connector is allowed through the through holes 206a.

The backflow shutoff float 203 is formed in a disk-like shape made of a material capable of floating in the UV ink and is put on the supporting member 206 to close the upper open end of the supporting member 206. A disk-like sealing rubber 207 is attached to the upper surface of the backflow shutoff float 203. When the backflow shutoff float 203 moves to the uppermost position together with the liquid surface of the UV ink, the sealing rubber 207 comes in contact with the lower end of the upper tube connector 204 projecting from the top wall into the inner space 201 of the housing 202 to close the lower open end of the introduction passage 204a of the upper tube connector. While the backflow shutoff float 203 floats n the UV ink and vertically moves together with the liquid surface of the UV ink as mentioned above, the backflow shutoff float 203 does not move vertically due to force of sucking air within the inner space 201 of the housing through the introduction passage 204a of the upper tube connector by the sub tank depressurizing unit 140.

At the center of the upper surface of the backflow shutoff float 203, a rod-like guide member 208 extending upwardly from the upper surface to a location near the lower end opening of the introduction passage 204a of the upper tube connector. The outer diameter of the guide member 208 is smaller than the diameter of the introduction passage 204a. The vertical movement of the backflow shutoff float 203 is guided as follows. When the backflow shutoff float 203 moves upwardly together with the liquid surface of the UV ink, the guide member 208 enters into the introduction passage 204a so that the sealing rubber 207 securely closes the lower end opening of the introduction passage 204a when the backflow shutoff float 203 reaches the uppermost position. The vertical movement of the backflow shutoff float 203 is guided so that the backflow shutoff float 203 securely closes the upper end opening of the supporting member 206 when the backflow shutoff float 203 reaches the lowermost position (i.e. normally).

As mentioned above, the negative pressure route 141 and the positive pressure route 151 are connected to the air pump 160 so as to form a single continuous route and distal ends of both the routes are converged so as to form a closed-loop-like pressurizing and depressurizing circuit. The converging route 171 to which the both routes are converted is connected to the sub tanks 120 through the converging route switch valve 175 and the backflow shutoff mechanisms 200 so that the ink storage chambers 123 of the sub tanks 120 are switchable between the depressurized state and the pressurized state by controlling the switching between the negative control valve 145 and the positive control valve 155.

In the ink supply device 100 having the aforementioned structure, the operations of the feed pumps 118, the negative pressure control valve 145, the positive pressure control valve 155, and the air pump 160 are controlled by the control unit 80 in the following manner. As apparent from the aforementioned description, the four systems (C, M, Y, and K) as systems for supplying UV inks have the same structures so that description will be made as regard to a single system by omitting subscripts representing respective systems.

(Control During Normal Operation)

As the main power switch of the printer apparatus P is turned ON, the control unit 80 reads out the control program stored in the ROM 81 and controls the operation of respective components of the printer apparatus according to the read control program. In the ink supply device 100, electric power is supplied to the air pump 160 to set the air pump 160 to the rotational driven state and all of the converging route switch valves 175 are turned ON. At this point, the negative pressure control valve 145 and the positive pressure control valve 155 are both kept in the OFF state. Therefore, in the negative pressure route 141, the communication between the line 147c and the line 147d is allowed so as to connect the inlet 161 of the air pump 160 and the ink storage chamber 123 of the sub tank 120 through the line 147 and the line 177. In the positive pressure route 151, the line 157c and the line 157x are connected so as to open the route on the outlet side of the air pump 160 to atmosphere.

Accordingly, air in the line 147 connected to the inlet 161 of the air pump is sucked to reduce the inner pressure of the air chamber 142 to a negative pressure so that the inner pressure of the air chamber 142 is stabilized at a substantially constant value defined according to the balance between the flow rate of entering air adjusted by the flow regulating valve 143a and the amount of air sucked by the air pump 160. As mentioned above, the inner pressure is set to be a predetermined negative pressure value (for example, a preset negative pressure of −1.2 kPa) in a range of from about −1 to −2 kPa which is suitable for meniscus formation at the nozzle portion of the print head 60, that is, the inner pressures of all of the ink storage chambers 123 of the four sub tanks are stably held at the same preset negative pressure.

At this time, in the positive pressure route 151, the route on the outlet side of the air pump 160 is opened to atmosphere so that air sucked from the negative pressure route 141 is released to atmosphere through the silencer 158. Therefore, the pressure (back pressure) of the positive pressure route 151 does not rise so that the suction efficiency of the air pump 160 is not lowered, thereby keeping the stable negative pressure state.

According to the detected signal inputted from the pressure sensor 144 to the control unit 80, it can be determined whether the inner pressure of the ink storage chamber 123 is kept at the preset negative pressure. When it is determined that the pressure detected by the pressure sensor 144 is out of a certain range from the preset negative pressure, for example, the detected pressure exceeds ±20% relative to the preset negative pressure, the control unit 80 may alarm that the pressure is out of the range (the pressure singularity of the negative pressure route). In this case, it is checked whether the respective components of the negative pressure route are normal. When all of these are normal, the inner pressure of the ink storage chamber is set to the proper preset negative pressure by adjusting the flow regulating valve 143a.

In operation, normally, some degree of UV ink is stored in the ink storage chamber 123 of the sub tank 120. In accordance with the start of the print program or the like, the UV ink retained in the ink storage chamber 123 is ejected from the nozzles of the print head 60 and is thus consumed so that the UV ink retained is gradually reduced. Since the ink supply device 100 is provided with the sub tank reserve detecting unit 130, the UV ink stored in the main tank 110 is supplied to the sub tank by the ink sending unit 115 when the amount of the UV ink retained in the ink storage chamber 123 becomes a predetermined amount or less, thereby replenishing the sub tank with the UV ink.

Specifically, When the UV ink retained in the ink storage chamber 123 is reduced and the residual amount of the UV ink becomes a predetermined value or less, the level detecting float 134 moving vertically together with the liquid surface of the UV ink is detected by the Lo detection sensor 136L which is disposed on the level detection plate 135. The control unit 80 receives the detection signal of the Lo detection sensor 136L from the level detection plate 135 and actuates the feed pump 118 in a state that the inner pressure of the ink storage chamber 123 is reduced to be a negative pressure. The UV ink sent from the main tank 110 by the feed pump is supplied to the ink storage chamber 123 through the line 117b and the tube connector 128 so as to increase the amount of the ink stored in the ink storage chamber. When the level detecting float 134 is detected by the Hi detection sensor 136H, the feed pump 118 is stopped, thereby completing the replenishment of the UV ink to the ink storage chamber 123.

In this manner, since the replenishment of the UV ink to the sub tank 120 is conducted in the state that the pressure in the ink storage chamber 123 is reduced, the UV ink is securely sent even with the small-size feeding pump and ink never leaks or dribbles from the nozzles of the print head 60 during the replenishment of the UV ink. If the pressure in the ink storage chamber 123 rises during the replenishment of the UV ink according to the relationship between the volume of the ink storage chamber 123 and the volume of the air chamber 142, the pressure in the ink storage chamber 123 is kept constant without being increased by increasing the rotation speed of the air pump 160 or reducing the opening degree of the flow regulating valve 143a, or conducting both of these according to the pressure detected by the pressure sensor 144. As the printer apparatus P is actuated, the air pump 160 is continuously operated so that the inner pressure of the sub tank 120 is always kept at the preset negative pressure whenever the print program is conducted even when waiting.

As mentioned above since the replenishment of the UV ink is conducted in the state that the ink storage chamber 123 is decompressed, there is an advantage that the replenishment of the UV ink is securely conducted and ink never leaks or dribbles from the nozzles of the print head 60, while there is a possibility that the UV ink flows out (flows backward) from the air introduction passage formed in the top wall 121t of the reservoir member 121 to the converging route switch valves 175 through the tube connector 129 and the line 177 when, for example, the feed pump 118 is not stopped due to failure of the Hi detection sensor 136H or the like so that the replenishment of the UV ink is continued even after the liquid surface of the UV ink in the ink storage chamber 123 rises to exceeds the reference level for filling. For this, the ink storage chamber 123 is, provided with the backflow prevention section 132 of which the sealing float 133 rises together with the liquid surface of the UV ink and comes in contact with the top wall 121t when the liquid surface of the UV ink in the ink storage chamber rises and exceeds the reference level for filling, thereby closing the, opening at the lower end of the aforementioned air introduction passage and thus preventing the backflow of the UV ink.

However, there is a possibility that the backflow prevention section 132 fails to work because the rise of the liquid surface is too fast to allow the sealing float to catch up with the rise of the liquid surface of the UV ink or because the sealing float 133 is stuck to the float supporting member 132a and thus does not rise together with the liquid surface of the UV ink. For this, the backflow shutoff mechanism 200 is disposed on the line 177 connecting the sub tank 120 and the converging route switch valve 175, whereby the backflow of the UV ink is shut off by the backflow shutoff mechanism 200 when the UV ink flows backward from the sub tank 120 through the line 177.

Specifically, the UV ink, flowing out from the air introduction passage of the top wall 121t through the tube connector 129 and the line 177 because the backflow prevention section 132 in the ink storage chamber fails to work, flows into the housing 202 through the derivation passage 205a of the lower tube connector 205 connected to the line 177 and is initially stored in the inner space 201 of the housing through the through holes 206a formed in the peripheral surface of the supporting member 206 (see arrows in FIG. 9(a)). Then, when the liquid surface of the UV ink in the inner space 201 exceeds the upper end of the supporting member 206, the backflow shutoff float 203 is pushed upwardly by the UV ink flowing into the inner space 201 through the opening formed in the upper end of the supporting member 206 so as to rise together with the liquid surface of the UV ink, so that the sealing rubber 207 attached to the upper surface of the float comes in contact with the lower surface of the upper tube connector 204 so as to close the opening at the lower end of the introduction passage 204a of the upper tube connector 204 (see FIG. 9(b)).

As mentioned above, when the UV ink flows backward from the sub tank 120 and reaches the backflow shutoff mechanism 200, the backflow shutoff float 203 rises together with the liquid surface of the UV ink in the inner space 201 and the opening at the lower end of the introduction passage 204a of the upper tube connector is closed by the sealing rubber 207, thereby preventing the UV ink from flowing out of the upper, tube connector 204 toward the converging route switch valve 175. By this backflow shutoff mechanism 200 having the simple structure as mentioned above, the backflow of the UV ink is securely shut off. As a result of this, the converging route switch valve 175, the negative pressure control valve 145, and the like are prevented from being damaged with UV ink flowing backward from the sub tank 120. Since the backflow shutoff float 203 is in contact only with the upper edge of the cylindrical supporting member 206 in the housing 202, the backflow shutoff float 203 never be stick to the other member, thereby ensuring the performance of the backflow shutoff action.

(Control During Ink Filling)

At the time of the initial filling of UV ink or the start up after nozzle cleaning with cleaning liquid, there is a case that any UV ink does not exist in the ink chamber of the print head 60 and the line 117 of the main supply route. At the restart after it has been left for a predetermined period of time or the restart after replacement of the main tank, there is a case that air bubbles are mixed in the UV ink. In such a case, according to the ink filling command inputted from the operational panel 88 into the control unit 80, the control for the ink filling is carried out as follows.

As a command for carrying out the ink filling is inputted into the control unit 80 by pushing a function key or the like of the operational panel 88 to select an “ink filling” process and specify one of the print heads 60, the arithmetic processing section 83 carries out a process of turning ON the converging route switch valve corresponding to the print head, of which ink filling is required, and turning OFF the other converging route switch valves in the state the inner pressure of the sub tank is kept to be the preset negative pressure for the normal operation (that is, the negative pressure control valve 145 and the positive pressure control valve 155 are both in the OFF state) (negative pressure keeping step). For example, in case that only the first print head 60C is selected as the print head, of which the ink filling is required, by the operational panel 88, only the first converging route switch valve 175C corresponding to the first print head 60C is turned ON and the second through fourth converging route switch valves 175M, 175Y, 175K corresponding to the second through fourth print heads are turned OFF (hereinafter, description will be made with reference to this case).

The ink is sent from the first main tank 110C to the first sub tank 120C of which inner pressure is reduced, thereby filling the first sub tank 120C with the ink (ink replenishment step). That is, only the feed pump 118C corresponding to the first sub tank 120C is actuated, whereby the UV ink stored in the first main tank 110C is supplied to the first sub tank 120C. The feed pump 118C is stopped when the level detection float 134 is detected by the Hi detection sensor 136H. Accordingly, an enough amount of the UV ink is stored in the ink storage chamber 123 of the first sub tank 120C. If the level detection float 134 is already detected by the Hi detection sensor 136H so that it is determined that UV ink is stored to reach the reference level for filling at the start of the ink replenishment step, the ink replenishment step is skipped and the next step (print head ink filling step) is conducted.

Then, the negative pressure route 141 is shut off and the inner pressure of the first sub tank 120C is increased into a positive pressure by the sub tank pressurizing unit 150, thereby dropping a part of the UV ink stored in the first sub tank 120C from the first print head 60C (print head ink filling step). Specifically, the control unit 80 turns ON the negative pressure control valve 145 to shut off the communication between the line 147c and the line 147d and connect the line 147c to the line 147x so as to open the route on the inlet side of the air pump 160 to the atmosphere. In addition, the control unit 80 turns ON the positive pressure control valve 155 to allow the communication between the line 157c and the line 157d so as to connect the outlet 162 of the air pump and the ink storage chamber 123 of the first sub tank 120C.

By this switch control, the communication between the air pump 160 and the first sub tank 120C through the negative pressure route 141 is shut off while the communication between the air pump 160 and the first sub tank 120C through the positive pressure route 151 is allowed so that air discharged from the outlet 162 of the air pump 160 is supplied to the ink storage chamber 123 of the first sub tank 120C through the line 157, the line 177, the line 177C, and the first backflow shutoff mechanism 200C. As mentioned above, the feed pump 118 is a pump capable of shutting off the pressure applied from either of the ink suction line 117a and the ink sending line 117b on the both sides of the feed pump 118. Therefore, the UV ink in the first sub tank 120C never flows backward to the first main tank 110C so that the inner pressure of the first sub tank 120C is increased and becomes in the positive pressure state having a pressure (for example, about 20 kPa) set by the adjustment of the flow regulating valve 153a. As a result, the UV ink stored in the ink storage chamber 123 of the first sub tank 120C is forced through the first derivation passage 127a in a lower portion of the tank and the second derivation passage 126b and is supplied to the first print head 60C. Then, the UV ink dropping from the nozzles of the first print head 60C is received by the ink tray 180.

During this, since the route on the inlet side of the air pump 160 in the negative pressure route 141 is opened to atmosphere, the air pump 160 is operated with little or no load on the inlet side. Therefore, the suction pressure of the air pump never be reduced so that the discharge efficiency also never be reduced, thereby securely filling the ink chamber of the first print head 60C with the UV ink. In addition, the first sub tank 120C can be switched between the depressurized state and the pressurized state by simple control of turning on the negative control valve 145 and the positive control valve 155 with keeping the rotation of the air pump 160 in a certain direction.

The print head ink filling step is continued until the ink chamber is filled with UV ink and the UV ink drops from the nozzles at the lower surface of the head even when the ink chamber of the first print head 60C is empty. For example, a timer is set for duration of this step (time setting) based on the time required for supplying the UV ink to the first print head 60C of which the ink chamber is empty by pressurizing the first sub tank 120C until a certain amount of UV ink flows out of the nozzles. Alternatively, it is defined (according to the amount of ink) that it is a time when the UV ink stored in the ink storage chamber 123 flows out and the level detection float 134 is detected by the Lo detection sensor 136L disposed on the level detection plate 135.

By the print head ink filling step, the areas from the ink storage chamber 123 of the first sub tank 120C to the nozzles of the first print head 60C are filled with the UV ink. At this point, the air bubbles, if any, in the lines are forced out through the nozzles so that the area from the first sub tank 120C to the first print head 60C is filled with the UV ink. Then, the process proceeds to the next step (sub tank filling step). At this point, the converging route switch valves 175 other than the first converging route switch valve 175C are in the closed state so that the inner pressures of the second through fourth sub tanks are held in the initial negative pressure.

Then, the positive pressure route 151 is shut off and the inner pressure of the first sub tank 120C is reduced to a negative pressure by the sub tank depressurizing unit 140. The ink is sent from the first main tank 110C into the first sub tank 120C with the reduced pressure by the ink sending unit 115, thereby filling the first sub tank 120C with the UV ink (sub tank ink filling step). That is, the control unit 80 turns OFF the positive pressure control valve 155 to shut off the communication between the line 157c and the line 157d and connect the line 157c to the line 157x so as to open the route on the outlet side of the air pump 160 to the atmosphere. In addition, the control unit 80 turns OFF the negative pressure valve 145 to allow the communication between the line 147c and the line 147d and connect the inlet 161 of the air pump to the ink storage chamber 123 of the first sub tank 120C.

By this switch control, the communication between the air pump 160 and the first sub tank 120C is shut off in the positive pressure route 151, while the air pump 160 and the first sub tank 120C are connected in the negative pressure route 141 so that air in the ink storage chamber 123 of the first sub tank is sucked by the air pump 160 through the first backflow shutoff mechanism 200C, the line 177C, the line 177 and the line 147. Accordingly, the inner pressure of the first sub tank 120C is reduced from a positive pressure to a negative pressure. The control unit 80 actuates the feed pump 118C when the pressure detected by the pressure sensor 144 becomes a negative pressure below a predetermined value (for example, −0.8 kPa or less) and stops the feed pump 118C when the level detection float 134 is detected by the Hi detection sensor 136H. Accordingly, the UV ink stored in the first main tank 110 is supplied into the ink storage chamber 123 of the first sub tank 120C and the ink storage chamber 123 of the first sub tank 120C is filled with the UV ink until the liquid level reaches the reference level for filling.

Then, the inner pressure of the first sub tank 120C detected by the pressure sensor 144 is reduced to be a value near the preset negative pressure (for example, about −1.0 kPa). When the inner pressure reaches this value or less, the second through fourth converging route switch valves 175M, 175Y, and 175K which have been closed until now are opened so that all of the first and fourth sub tanks are kept at the preset negative pressure (negative pressure keeping step). Then, the ink filling is terminated. In this manner, the first print head 60C selected by the operation panel 88 is filled with ink and all sub tanks including the first sub tank are set at the preset negative pressure and are held in the standby state. It should be noted that, in case of carrying out the ink filling process onto a plurality of print heads, the same process as mentioned above will be carried out by turning ON the converging route switch valves corresponding to the print heads of which ink filling is required.

Now, as another embodiment of the backflow shutoff mechanism of the ink supply device 100, different from the aforementioned backflow shutoff mechanism 200, a backflow shutoff mechanism 300 will be described. It should be noted that, in the following description, components the same as the components of the aforementioned ink supply device 100 are marked with the same numerals so that the explanation about those components will be omitted.

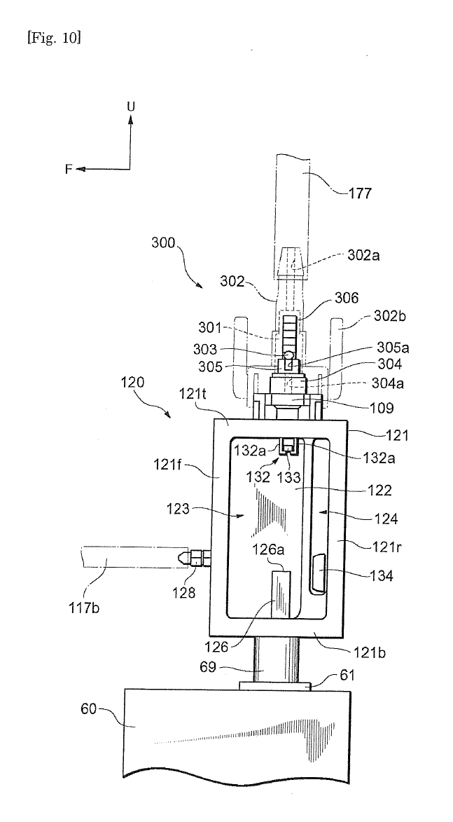

The backflow shutoff mechanisms 300 are disposed between the converging route switch valves 175 and the sub tanks 120 in the ink supply device 100 to correspond to the first through fourth sub tanks 120C, 120M, 120Y, 120K, respectively. As shown in FIG. 10, each backflow shutoff mechanism 300 is directly connected to a shutoff mechanism connector 109 which is formed to communicate with the air introduction passage of the top wall 121t at the upper portion of the sub tank 120. The backflow shutoff mechanism 300 mainly comprises a housing 302 which has a release mechanism 302b and is thus detachably attached to the shutoff mechanism connector 109, and a backflow shutoff float 303 which is accommodated in an inner space 301 formed in the housing 302 and which vertically move together with the liquid surface of UV ink flowing into the inner space. It should be noted that in FIG. 10, the housing 302 is shown virtually by two dot chain lines for the purpose of showing the structure inside of the housing 302.

The housing 302 is provided with the inner space 301 which extends in the vertical direction and opens the lower surface of the housing 302. A cylindrical shield member 304 is fitted in the opening at the lower surface, thereby keeping the inner space 301 in the sealed state. The line 177 connected to the converging switch valve 175 is connected to the upper portion of the housing 302 so that the converging route 171 and the inner space 301 of the housing are connected through an introduction passage 302a extending from the upper end to the inner space 301 of the housing. The shield member 304 keeps the inner space 301 in the sealed state and is also in contact with the upper surface of the shutoff mechanism connector 109 to prevent air from leaking out of this contact portion when the backflow shutoff mechanism 300 is attached to the shutoff mechanism connector 109, whereby the inner space 301 and the shutoff mechanism connector 109 are connected through a derivation passage 304a penetrating through the shield member 304 in the vertical direction.

In the inner space 301 of the housing 302, a cylindrical supporting member 305 bored in the vertical direction is mounted on the upper surface of the shield member 304 and the backflow shutoff float 303 and a guide member 306 are disposed on the supporting member 305. In the peripheral surface of the supporting member 305, a penetration slit 305a which penetrates through the peripheral surface and extends to the top is formed. Normally (when no backflow UV ink is stored in the inner space 301), the communication between the inner space 301 of the housing and the derivation passage 304a of the shield member 304 is allowed through the penetration slit 305.

The backflow shutoff float 303 is formed in a spherical shape made of a material capable of floating in the UV ink and is put on the supporting member 305 to close the upper open end of the penetration slit 305a of the supporting member 305. The diameter of the backflow shutoff float 303 is larger than the diameter of the introduction passage 302a of the housing. The guide member 306 is formed in a cylindrical shape using a net frame. The guide member 306 accommodates the backflow shutoff float 303 inside thereof and extends from the upper surface of the supporting member 305 to a portion near the lower open end of the introduction passage 302a to guide the vertical movement of the backflow shutoff float 303.

As for the backflow shutoff mechanism 300 having the aforementioned structure, the UV ink, flowing out from the air introduction passage of the top wall 121t through the shutoff mechanism connector 109 because the backflow prevention section 132 in the ink storage chamber 123 of the sub tank 120 fails to work as mentioned above, flows into the housing 302 through the derivation passage 304a of the shield member 304 connected to the shutoff mechanism connector 109 and is initially stored in the inner space 301 of the housing through the penetration slit 305a formed in the peripheral surface of the supporting member 305. Then, when the liquid surface of the UV ink in the inner space 301 exceeds the upper end of the supporting member 305, the backflow shutoff float 303 is pushed upwardly by the UV ink flowing into the inner space 301 through the opening formed in the upper end of the supporting member 305 so that the backflow shutoff float 303 is guided by the guide member 306 to rise together with the liquid surface of the UV ink and come in contact with the portion near the lower open end of the introduction passage 302a of the housing to close the lower open end.

As mentioned above, when the UV ink flows backward from the sub tank 120 and reaches the backflow shutoff mechanism 300, the backflow shutoff float 303 rises together with the liquid surface of the UV ink in the inner space 301 and the opening at the lower end of the introduction passage 302a of the housing is closed by the backflow shutoff float 303, thereby preventing the UV ink from flowing out of the introduction passage 302a toward the converging route switch valve 175 and thus securely shutting off the backflow of the UV ink in the backflow shutoff mechanism 300. Since the backflow shutoff mechanism 300 is directly attached to the shutoff mechanism connector 109 formed on the sub tank 120, the UV ink flowing backward from the sub tank 120 reaches the backflow shutoff mechanism 300 immediately and the backflow of ink is shut off by the backflow shutoff mechanism 300 as mentioned above, thereby preventing the line 177 from being contaminated by the UV ink flowing backward. Therefore, the number of parts which will be forced to be replaced because of being contaminated when backflow of ink occurs is reduced. As a result of this, an effect of reducing the maintenance cost of the printer apparatus P is obtained. Since the backflow shutoff float 303 having the spherical shape is in contact with the other member (for example, the supporting member 306 and the housing 302) by a small area, the backflow shutoff float 303 never be stick to the other member, thereby ensuring the performance of the backflow shutoff action.

Though the preferred embodiments of the present invention have been described in the above, the range of the present invention is not limited to the aforementioned embodiments. For example, though as one example of the inkjet printer to which the present invention is applied, an inkjet printer which conducts the printing process by moving a print head (carriage) relative to a print medium held on a platen in a direction of one axis (Y axis) of two orthogonal axes extending horizontally and feeding the print medium on the platen in a direction of the other axis (X axis) during the printing process is employed in the aforementioned embodiment, the present invention can be applied to an inkjet printer of another type, such as an inkjet printer which conducts a printing process onto a print medium fixedly held on a supporting table (so-called, inkjet printer of a flat bed type), and an inkjet printer which conducts a printing process by putting a print medium such as a CD onto a pallet and moving the pallet by a belt conveyer.

### EXPLANATION OF REFERENCE SIGNS IN DRAWINGS

P printer apparatus (inkjet printer)
60 print head (60C: first print head, 60M: second print head, 60Y: third print head, 60K: fourth print head)
100 ink supply device
109 shutoff mechanism connector (air introduction port)
110 main tank (110C: first main tank, 110M: second main tank, 110Y: third main tank, 110K: fourth main tank)
115 ink sending unit (ink sending means)
120 sub tank (120C: first sub tank, 120M: second sub tank, 120Y: third sub tank, 120K: fourth sub tank)
140 sub tank depressurizing unit (pressure control means)
150 sub tank pressurizing unit (pressure control means)
160 air pump (pressure control means)
171 converging route (air passage)
200 backflow shutoff mechanism (200C: first backflow shutoff mechanism, 200M:

second backflow shutoff mechanism, 200Y: third backflow shutoff mechanism, 200K:

fourth backflow shut off mechanism) (backflow shutoff means, backflow shutoff mechanism)
201 inner space (air flowing space)
202 housing (housing member)
203 backflow shutoff float (float member)
204a introduction passage (first air introduction passage)
205a derivation passage (second air introduction passage)
300 backflow shutoff mechanism (backflow shutoff means, backflow shutoff mechanism)
301 inner space (air flowing space)
302 housing (housing member)
302a introduction passage (first air introduction passage)
303 backflow shutoff float (float member)
304a derivation passage (second air introduction passage)

1.-5. (canceled)

6. An ink supplying system, comprising:
a subtank being in fluid communication with a main tank, a print head, and a pump, such that ink flows into the subtank from the main tank and ink flows out of the subtank to the print head, and the pump is capable of providing a pressure at the subtank; and
a back flow regulator external to the subtank capable of substantially regulating fluid communication between the subtank and the pump.

7. The ink supplying system of claim 6, wherein the back flow regulator is designed such that ink flowing out of the subtank is substantially prevented from reaching the pump.

8. The ink supplying system of claim 6, wherein the pressure at the subtank is negative relative to atmospheric pressure.

9. The ink supplying system of claim 6, wherein the pressure at the subtank is at least one of negative relative to atmospheric pressure and substantially equal to atmospheric pressure.

10. The ink supplying system of claim 6, wherein the back flow regulator is a mechanical valve.

11. The ink supplying system of claim 6, wherein the mechanical valve further comprises,
a housing having a top opening and a bottom opening;
a float located within the housing, the density of the float being less than that of ink; and
the float being capable of substantially sealing the top opening.

12. The ink supplying system of claim 11, wherein the float located in the housing is coupled to a guide member.

13. The ink supplying system of claim 11, wherein ink received in the bottom opening flows in a first direction and then flows into the housing at an angle substantially perpendicular to the first direction.

14. The ink supplying system of claim 6, wherein the subtank further comprises,
a housing having a top opening, side opening, and a bottom opening;
a float located within the housing, the density of the float being less than that of ink; and
the float being capable of substantially sealing the top opening when a predetermined volume of ink is in the housing.

15. A back flow regulator, comprising:
a housing having a first opening being in fluid communication with a pump and a second opening being in fluid communication with a subtank;
a float located within the housing, the density of the float being less than that of ink; and
wherein the float substantially regulates fluid communication between the housing and the pump.

16. The back flow regulator of claim 15, wherein the float substantially prevents fluid communication between the subtank and the pump.

17. The back flow regulator of claim 15, wherein the float located in the housing is coupled to a guide member.

18. The back flow regulator of claim 15, wherein the subtank is in fluid communication with a main tank and a print head.

19. The back flow regulator of claim 18, wherein when ink is supplied into the subtank from the main tank, the back flow regulator substantially prevents ink from passing between the subtank and the pump.
